(19) United States
(12) Patent Application Publication
(10) Pub. No.: US 2012/0056737 A1
(43) Pub. Date: Mar. 8, 2012

(54) RESTRAINT SYSTEM INCLUDING A DISENGAGED COUPLING APPARATUS INDICATOR

(75) Inventors: Marius Magdun, Cicero, IN (US); David D. Merrick, Rochester, NC (US)

(73) Assignee: INDIANA MILLS & MANUFACTURING, INC., Westfield, IN (US)

(21) Appl. No.: 13/139,559

(22) PCT Filed: Mar. 30, 2010
(86) PCT No.: PCT/US10/29132

§ 371 Date: Nov. 17, 2011

Related U.S. Application Data
(60) Provisional application No. 61/166,138, filed on Apr. 2, 2009.

(51) Int. Cl. B60Q 1/00

(52) U.S. Cl. 340/457.1

(57) ABSTRACT

A restraint system for a motor vehicle includes a coupling member, a coupling apparatus configured to receive and engage the coupling member, at least one indicator, and an electrical circuit configured to determine whether the coupling member is engaged with the coupling apparatus and to control the at least one indicator to indicate whether the coupling apparatus is either of engaged and disengaged with the coupling member.

### CROSS REFERENCE TO RELATED APPLICATION

The application claims the benefit of and priority to U.S. Provisional Patent Application Ser. No. 61/166,138 filed Apr. 2, 2009, the disclosure of which is hereby incorporated by reference herein.

### FIELD OF THE INVENTION

The present invention relates generally to restraint systems, and more specifically to restraint systems configured to provide an indication of a disengaged coupling apparatus.

### BACKGROUND

Conventional occupant restraint systems for occupant transportation vehicles exist in many forms. It is desirable to provide for improved occupant restraint systems.

### SUMMARY

The present invention may comprise one or more of the features recited in the attached claims, and/or one or more of the following features and combinations thereof. A restraint system for a motor vehicle may comprise a coupling member, a coupling apparatus configured to receive and engage the coupling member, at least one indicator, and an electrical circuit configured to determine whether the coupling member is engaged with the coupling apparatus and to activate the at least one indicator if the coupling apparatus is not engaged with the coupling member.

The at least one indicator may comprise any one or combination of one or more audible indicators, one or more visual indicators, one or more tactile indicators and at least one indicator external to the coupling apparatus.

The coupling member may comprise a tongue member and the coupling apparatus may comprise a buckle member. The buckle member may be mounted to an occupant seat carried by the motor vehicle.

The electrical circuit may comprise a sensor configured to produce a sensor signal corresponding to a position of the coupling member relative to the coupling apparatus, and a processor including a memory having stored therein instructions that are executable by the processor to activate the at least one indicator if the sensor signal indicates that the coupling apparatus is not engaged with the coupling member.

A latch plate may be carried by and movable relative to the coupling apparatus. The coupling member may engage the latch plate when the coupling member is received by the coupling apparatus, and the coupling member may move the latch plate to a position at which the sensor signal indicates that the coupling apparatus is engaged with the coupling member when the coupling apparatus engages the coupling member. The sensor signal may otherwise indicate that the coupling apparatus is not engaged with the coupling member. The latch plate may include a sensing structure, and the sensor signal may indicate that the coupling apparatus is engaged with the coupling member when the sensing structure is positioned within sensing distance of the sensor. The sensing structure may illustratively comprise a magnet, and the sensor may illustratively comprise a Hall effect sensor.

The instructions stored in the memory may include instructions that are executable by the processor to activate the at least one indicator according to a predetermined indication pattern. Alternatively or additionally, the instructions stored in the memory may include instructions that are executable by the processor to sequentially activate the at least one indicator according to the predetermined indication pattern. Alternatively or additionally still, the instructions stored in the memory may include instructions that are executable by the processor to sequentially activate the at least one indicator according to the predetermined indication pattern with a predetermined time delay between each activation of the at least one indicator according to the predetermined indication pattern.

In embodiments that include at least one visual indicator, the at least one visual indicator may comprise at least one light emitting diode carried by the coupling apparatus, wherein the at least one light emitting diode is visible externally to the coupling apparatus when activated.

In embodiments that include at least one audible indicator, the audible indicator is illustratively audibly perceptible external to the coupling apparatus when activated.

In embodiments which include at least one indicator external to the coupling apparatus, the electrical circuit may further comprise a switch having a voltage input configured to receive voltage from a voltage source carried by the motor vehicle, a voltage output configured to be connected to the indicator external to the coupling apparatus, and a control input electrically connected to the processor. The instructions stored in the memory may include instructions that are executable by the processor to control the switch via the control input thereof to activate the indicator external to the coupling apparatus if the sensor signal indicates that the coupling apparatus is not engaged with the coupling member.

A restraint system for a motor vehicle may comprise a coupling member,

a coupling apparatus configured to receive and engage the coupling member, at least one indicator, and an electrical circuit configured to determine whether the coupling member is engaged with the coupling apparatus and to control the at least one indicator to indicate whether the coupling apparatus is either of engaged and disengaged with the coupling member.

The electrical circuit may be configured to control the at least one indicator to indicate when the coupling apparatus is engaged with the coupling member and when the coupling apparatus is disengaged with the coupling member. The at least one indicator may be configured to provide a visual distinction between when the coupling apparatus is engaged with the coupling member and when the coupling apparatus is disengaged with the coupling member.

### BRIEF DESCRIPTION OF THE DRAWINGS

FIG. 1 is a diagram of one side of an occupant seat for a motor vehicle having mounted thereto one illustrative embodiment of a restraint system including a coupling apparatus with a disengagement indicator.

FIG. 2 is a diagram of an opposite side of the occupant seat illustrated in FIG. 1.

FIG. 3 is a perspective view of the top of the restraint system coupling apparatus illustrated in FIGS. 1 and 2.

FIG. 4 is a perspective view of the bottom of the restraint system coupling apparatus illustrated in FIGS. 1 and 2.

FIG. 5 is a front plan view of the restraint system coupling apparatus illustrated in FIGS. 1 and 2.

FIG. 6 is a top plan view of one illustrative embodiment of the interior of the bottom housing member of the restraint system coupling apparatus illustrated in FIGS. 1-5.

FIG. 7 is a perspective view of the interior of the bottom housing member of the restraint system coupling apparatus illustrated in FIG. 6.

FIG. 8 is a top plan view of the interior of the bottom housing member of the restraint system coupling apparatus illustrated in FIGS. 6-7 showing a coupling member in a disengaged position relative to the coupling apparatus.

FIG. 9 is a top plan view of the interior of the bottom housing member of the restraint system coupling apparatus illustrated in FIG. 8 showing the coupling member in an engaged position relative to the coupling apparatus.

FIG. 10 is a diagram of one illustrative embodiment of an electrical circuit configured to determine whether a coupling member is engaged or disengaged with the coupling apparatus illustrated in FIGS. 1-9, and to control at least one indicator to indicate the disengaged condition.

### DESCRIPTION OF THE ILLUSTRATIVE EMBODIMENTS

For the purposes of promoting an understanding of the principles of the invention, reference will now be made to a number of illustrative embodiments shown in the attached drawings and specific language will be used to describe the same.

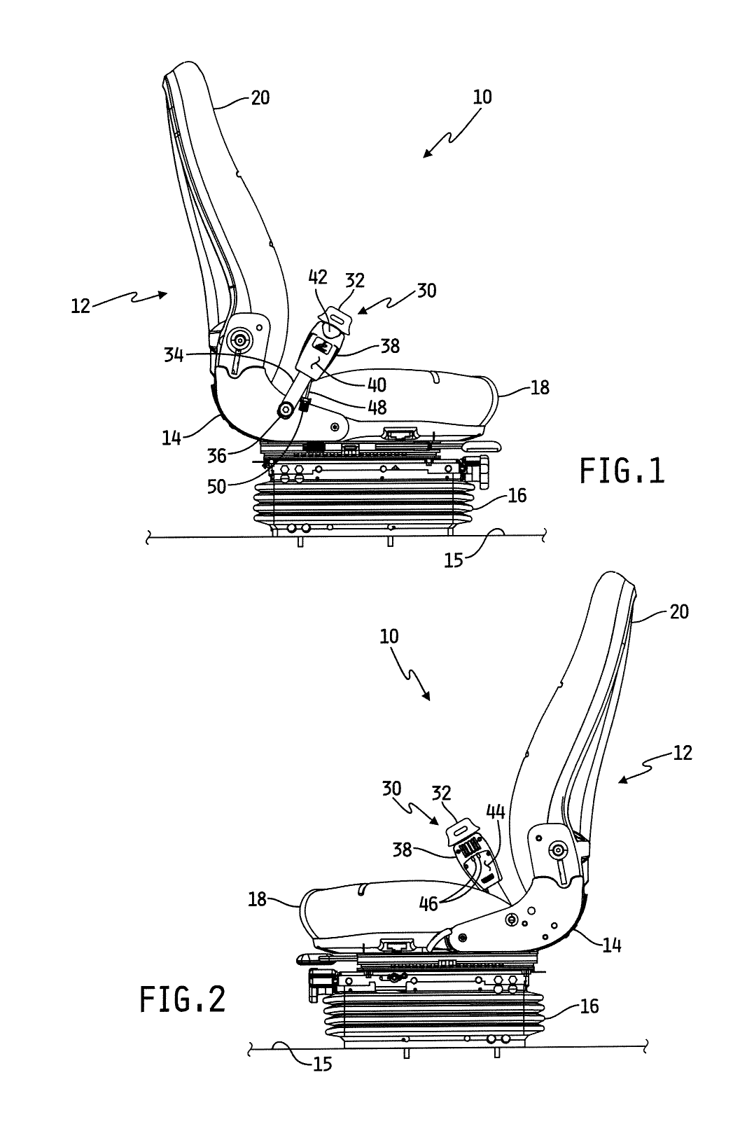

Referring now to FIGS. 1 and 2, opposite side views of an occupant seat 12 for a motor vehicle are shown that have mounted thereto one illustrative embodiment of a restraint system 10 including a coupling apparatus 30 with a disengagement indicator. Examples of motor vehicles include, but are not limited to, conventional motor vehicles, including cars, trucks, busses, industrial machinery, utility vehicles and the like, conventional aircraft or watercraft, single or multiple-track rail vehicles including trains, trams, trolleys, monorail transport systems and the like, and amusement park rides.

In the illustrated embodiment, the occupant seat 12 includes a seat frame 14 mounted to a seat base 16 that is mounted to a support surface, e.g., a floor, of the motor vehicle. A conventional seat bottom 18 is mounted to the seat frame 14 and/or seat base 16, and a conventional seat back 20 is mounted to the seat frame 14. The restraint system 10 includes a coupling apparatus 30 that is illustratively mounted to the seat frame 14 adjacent to one side of the occupant seat 12 as illustrated in FIGS. 1 and 2. The restraint system 10 further includes a coupling member 32 that is configured to be movably coupled to a conventional web (not shown) of a conventional restraint harness (not shown). The coupling apparatus 30 and the coupling member 32 are each configured for releasable engagement with each other in a conventional manner. In the illustrated embodiment, the coupling apparatus 30 is provided in the form of a buckle member and the coupling member 32 is provided in the form of a conventional tongue member. It will be understood, however, that in alternative embodiments the tongue member 32 may be mounted to the seat frame 14 adjacent one side of the occupant seat 12, and the buckle member 30 may be configured to be movably coupled to a web of the restraint harness.

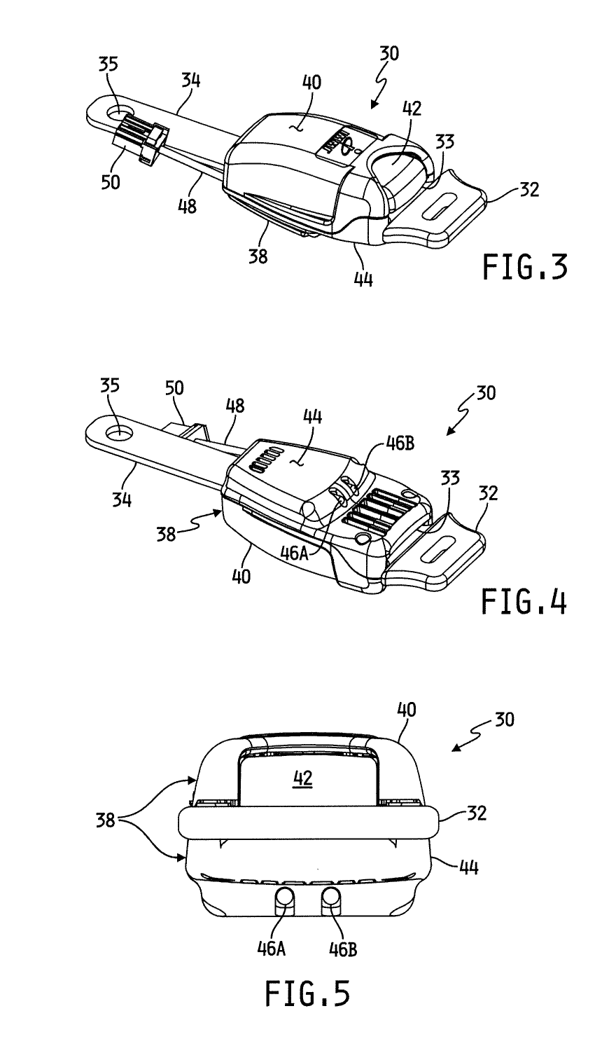

Referring now to FIGS. 1-5, the illustrated embodiment of the coupling apparatus 30 includes a mounting member 34 coupled to a housing 38 made up of a top housing member 40 and a bottom housing member 44. The top and bottom housing members 40 and 44 are formed to fit into engagement with each other to form the housing 38. One end of the resultant housing 38 defines a slot 33 configured to receive the coupling member 32 therein, and the mounting member 34 extends from the opposite end of the housing 38. Illustratively, the mounting member 34 is mounted within the housing to the bottom housing member 44 and/or the top housing member 40, although the mounting member 34 may alternatively be mounted to the end of the housing 38 opposite to the end defining the slot 33. In any case, the mounting member 34 illustratively defines an opening 35 therethrough that is sized to receive a conventional fastener 36 for attaching the mounting member 34, and thus the coupling apparatus 30, to the seat frame 14. In the illustrated embodiment, the mounting member 34 is a rigid mounting member formed of a suitable rigid material, e.g., steel, rigid plastic material, or the like, although the mounting member 34 may in other embodiments be formed of a suitable flexible or semi-flexible, e.g., semi-rigid, material.

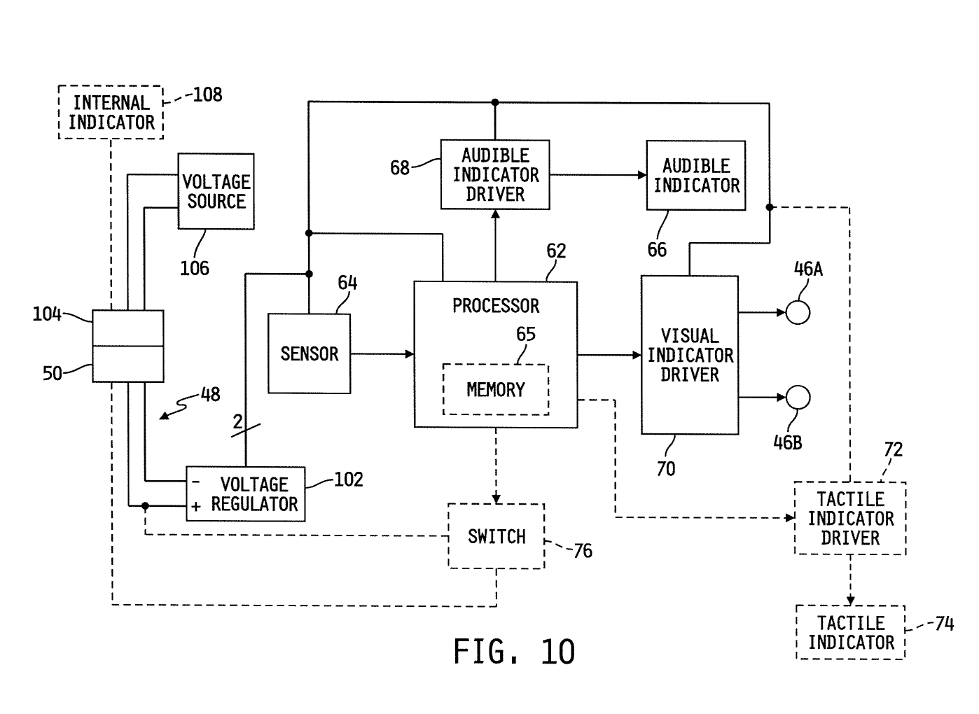

A release member 42 is carried by the housing 38, and is movable relative to the housing in a conventional manner to release the coupling member 32 from the coupling apparatus 30 when the coupling member 32 is engaged with the coupling apparatus 30. A disengagement indicator is provided in the form of two visual indicators 46A and 46B mounted within the housing 38 and visible through corresponding visual indicator ports formed into the bottom housing 44 such that they can be seen by an occupant of the occupant seat 12. Illustratively, the visual indicators 46A and 46B are provided in the form of conventional light emitting diodes (LEDs), although alternate light sources and/or other visual indicators, e.g., color coded materials, are contemplated. In alternate embodiments, the coupling apparatus 30 may include more or fewer visual indicators, and/or any such visual indicators may be located in other positions relative to the coupling apparatus 30. For example, one or more visual indicators may alternatively be mounted such that it/they is/are visible through the top housing 40, through the interface between the top and bottom housings 40, 44 and/or through the slot 33 defined by the top and bottom housings 40, 44. Alternatively still, as will be described in greater detail hereinafter with respect to FIG. 10, one or more visual, audible and/or vibratory indicators may alternatively or additionally be provided externally to the coupling apparatus 30. Such one or more external indicators may be installed in the motor vehicle, e.g., in the cab area of the motor vehicle, or may be or include one or more existing indicators, e.g., dome light, dash-mounted illuminator, cab-mounted chime or other audible indicator, vehicle warning horn, or the like.

An electrical cable 48 extends from the coupling apparatus 30 and is electrically connected to a conventional electrical connector 50. The electrical cable 48 contains a number of electrical wires, at least two of which provide an operating voltage and a ground reference to electrical circuitry carried by the housing 38. In some embodiments, the electrical cable 48 may contain one or more additional electrical wires for connection to one or more external indicators as just described.

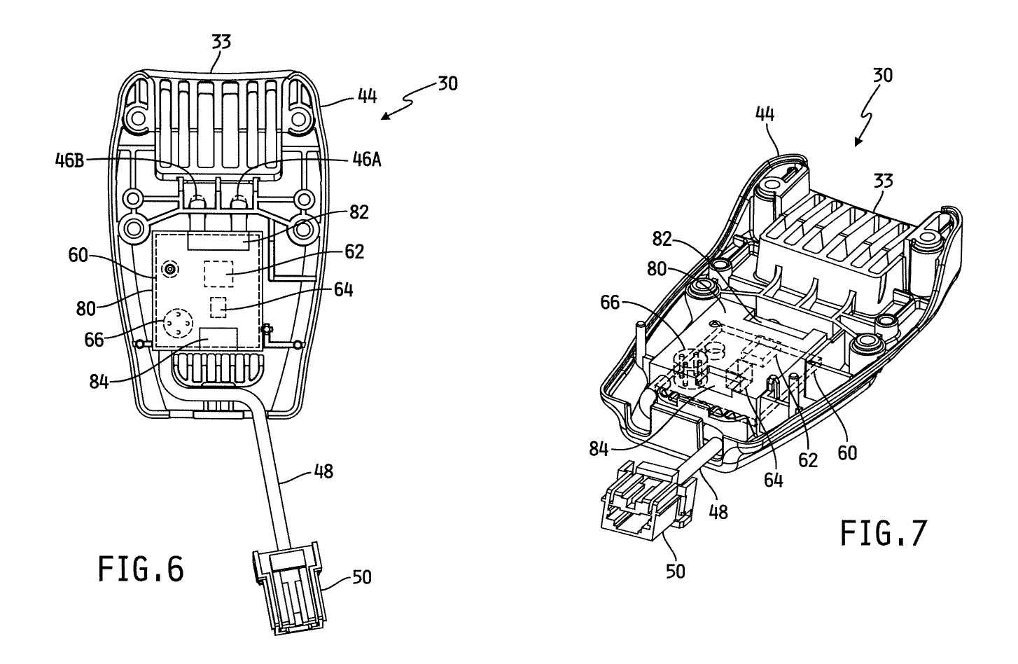

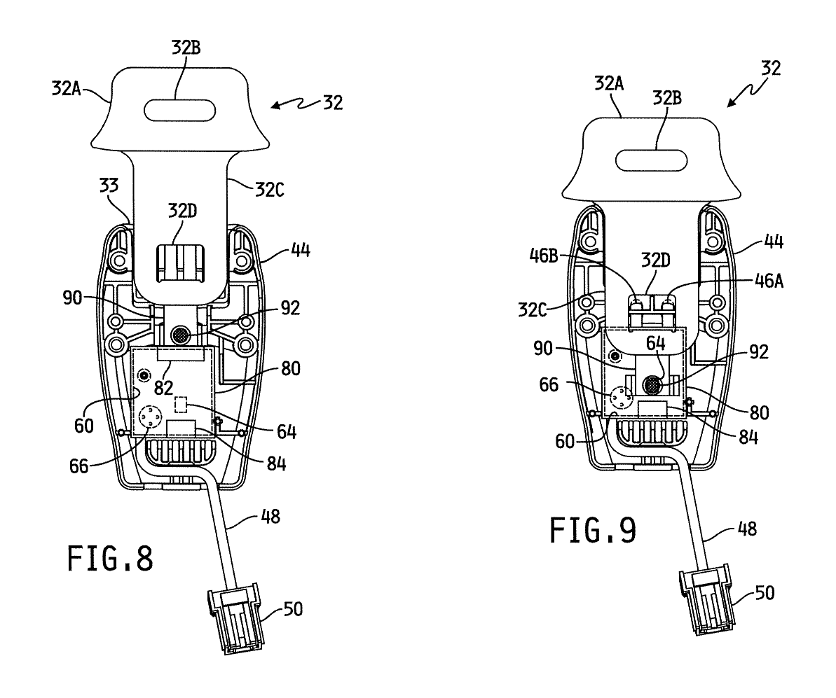

Referring now to FIGS. 6 and 7, top plan and perspective views respectively are shown of one illustrative embodiment of the interior of the bottom housing member 44 of the restraint system coupling apparatus 30 illustrated in FIGS. 1-5. In the illustrated embodiment, a circuit board 60 is mounted to the bottom housing member 44, and a circuit board over-mold 80 is mounted to the bottom housing member 44 over the circuit board 60. One purpose of the circuit board over-mold 80 is to protect the circuit board 60 and electrical components mounted thereto from damage due to movement of various structure components of the coupling apparatus 30 during normal operation thereof. The circuit board over-mold 80 also defines a pair of slots 82 and 84 therein that are connected via a channel extending therebetween, the purpose of which will be described with respect to FIGS. 8-9.

In the embodiment illustrated in FIGS. 6 and 7, some of the electrical components mounted to the circuit board 60 are shown and include, for example, a processor 62, a sensor 64 and an audible device 66. Two LEDs 46A and 46B are electrically connected to the circuit board 60, but are mounted within the bottom housing member 44 separately from the circuit board 60 such that at least the top portions of the LEDs 46A and 46B can be seen externally to the bottom housing member 44 as illustrated in FIGS. 2, 4 and 5. The circuit board 60 generally will include more electrical components than those illustrated in FIGS. 6 and 7. Some such additional electrical components are shown in FIG. 10 and will be described in detail hereinafter. In any case, the electrical cable 48 is operatively connected to the circuit board 60 and extends from the circuit board 60 and from the bottom housing member 44, and terminates at the electrical connector 50.

Referring now to FIGS. 8 and 9, top plan views are shown of the interior of the bottom housing member 44 of the restraint system coupling apparatus 30 illustrating the coupling member 32 in disengaged, e.g., unlatched, and engaged, e.g., latched, positions respectively relative to the bottom housing member 44. In the illustrated embodiment, the circuit board 60 and some of the electrical components mounted to the circuit board 60 are shown by dashed line representation similarly to FIG. 6. In FIGS. 8 and 9, however, the processor 62 is omitted from the drawings so that the operation of the sensor 64 can be more clearly illustrated. It will be understood, however, that the circuit board 60 includes the processor 62 or operational equivalent thereof.

In the illustrated embodiment, the coupling member 32 includes a web coupling member 32A attached to or integral with a tongue member 32C. The web coupling member 32A illustratively defines a slot 32B through which a conventional web of a conventional restraint harness may extend. The tongue member 32C defines an opening 32D therethrough as is conventional. A latch plate 90 is carried by, and is movable relative to, the bottom housing member 44. The free end of the tongue member 32A of the coupling member 32 contacts one end of the latch plate 90 and moves the latch plate 90 to an engaged position within the bottom housing member 44 as the coupling member 32 advances into the bottom housing member 44 to the engaged or latched position. When the latch plate 90 is in the engaged position, the sensor signal produced by the sensor 64 indicates that the coupling apparatus 30 is engaged with the coupling member 32. Otherwise, the sensor signal produced by the sensor 64 indicates that the coupling apparatus 30 is not engaged with the coupling member 32. Illustratively, the latch plate 90 is biased (not shown) such that the latch plate 90 returns to an unengaged position when the coupling member 32 is disengaged or unlatched from the coupling apparatus 30 and withdrawn sufficiently from the bottom housing member 44.

Referring specifically to FIG. 8, the coupling member 32 is shown in an unengaged or unlatched position relative to the bottom housing member 44. In this position, the free end of the tongue member 32C is in contact with one end of the latch plate 90. As shown in FIG. 8, the latch plate 90 includes a sensing structure 92 mounted thereto or integral therewith. As the tongue member 32C advances into the bottom housing member 44 of the coupling apparatus 30 to the engaged or latched position, the tongue member 32C moves the latch plate 90 such that the sensing structure 92 is positioned within sensing distance of the sensor 64. As shown in FIG. 9, for example, when the tongue member 32C moves the latch plate 90 into the engaged position, the sensing structure 92 is positioned directly over, i.e., juxtaposed with, the sensor 64. In one embodiment, the sensing structure 92 is or includes a conventional permanent magnet and the sensor 90 is a conventional Hall effect sensor. In this embodiment, the Hall effect sensor 64 produces a signal indicative of the engaged or latched position of the engagement member 32 relative to the coupling apparatus 30 when the sensing structure including the magnet 92 is positioned sufficiently over, i.e., juxtaposed with, the sensor 64. Otherwise, the Hall effect sensor produces a signal, or no signal at all, which is indicates that the coupling apparatus 30 is not engaged with, or latched to, the coupling member 32. In some alternative embodiments, the sensor 64 may be or include a conventional proximity or position sensor and the sensing structure 92 may accordingly be a corresponding proximity or position sensible structure. In other alternative embodiments, the sensor 64 may be a conventional switch, e.g., such as a micro-switch or other suitable switch, and the latch plate 90 may be configured to activate the switch such that the switch produces a signal indicating that the coupling apparatus 30 is not engaged with, or latched to, the coupling member 32. It will be understood that this disclosure contemplates other embodiments in which the sensor 64 and sensing structure 92 may be any conventional sensor and corresponding sensing structure capable of distinguishing between engaged and unengaged positions of the coupling member 32 relative to the coupling apparatus 30.

Referring now to FIG. 10, a diagram is shown of one illustrative embodiment of an electrical circuit 100 configured to determine whether the coupling member 32 is engaged or disengaged with the coupling apparatus 30 illustrated in FIGS. 1-9, and to control at least one indicator to indicate the disengaged condition. In the illustrated embodiment, the circuit 100 includes the processor 62, the latch sensor 64, the audible indicator 66 and the LEDs 46A and 46B illustrated and described with respect to FIGS. 6-9. The processor 62 is illustratively a conventional microprocessor including a memory 65 having instructions stored therein that are executable by the microprocessor to determine whether the coupling apparatus is engaged or disengaged with the coupling member 32 and to control at least one indicator to indicate the disengaged condition. Alternatively, the processor 62 may be or include one or more digital and/or analog circuits configured to make such a determination and control at least one indicator accordingly.

The electrical circuit 100 further illustratively includes an audible indicator driver circuit 68 having an input electrically connected to an output of the processor 62, and an output electrically connected to the audible indicator 66. The audible indicator driver circuit 68 may be conventional, and is configured to be responsive to a control signal produced by the processor 62 to activate the audible indicator 66. In one embodiment, the audible indicator 66 is a conventional speaker and the audible indicator driver circuit 68 is a conventional tone generating circuit, although this disclosure contemplates other conventional audible driver circuits including, for example, but not limited to, musical note generating circuits, synthesized speech generating circuits, and the like, as well as other types of audible indicators including, for example, but not limited to, conventional beepers, buzzers, and the like.

The electrical circuit 100 further includes a visual indicator driver circuit 70 having at least one input electrically connected to an output of the processor 62, and outputs electrically connected to each of the visual indicators 46A and 46B. In embodiments in which the visual indicators are implemented in the form of LEDs, the visual indicator driver circuit 70 may be a conventional LED driver circuit. This disclosure contemplates other embodiments which include more or fewer visual indicators, and/or in which one or more visual indicators are or include one or more other conventional visual indicators including, for example, but not limited to, one or more conventional lamps, one or more color coded indicators, one or more conventional liquid crystal display devices, one or more conventional vacuum fluorescent display devices, one or more conventional analog display devices, and the like.

In some embodiments, the electrical circuit 100 may further include a tactile indicator driver circuit 72 having an input electrically connected to an output of the processor 62, and an output electrically connected to a tactile indicator 74 as shown by dashed-line representation in FIG. 10. In such embodiments, the tactile indicator 74 may be a conventional tactile indicator, one example of which includes, but should not be limited to, a conventional vibrator, and tactile indicator driver circuit 72 may be a conventional vibrator driver circuit. This disclosure contemplates other embodiments which include multiple tactile indicators, and/or in which one or more tactile indicators are or include one or more other conventional tactile indicator devices.

In one illustrative embodiment, the memory 65 includes instructions that are executable by the processor 62 to simultaneously activate the audible indicator 66 and the visual indicators 46A, 46B a number of times, e.g., 5, at predefined intervals, e.g., 1 second, followed by a predetermined time delay, e.g., 2 minutes, and to repeat this sequence some number of times, e.g., 5 times, upon detection by the sensor 64 of an disengaged or unlatched coupling member 32 condition. It will be understood, however, that this represents only one example embodiment, and that the memory is generally programmable to provide for any desired pattern or sequence of any one or combination of the various indicator devices. For example, the instructions stored in the memory may be programmed such that the processor activates at least one of the indicators according to a predetermined indication pattern, to sequentially activate at least one of the indicators according to a predetermined indication pattern, and/or to sequentially activate at least one indicator according to a predetermined indication pattern with a predetermined time delay between each activation and/or sequence of activations. Those skilled in the art will recognize other indicator activation patterns and/or sequences, and any such other indicator activation patterns and/or sequences are contemplated by this disclosure.

It will be understood that while the embodiment of the electrical circuit 100 illustrated in the attached figures include one audible indicator 66 and two visual indicators 46A and 46B, the electrical circuit 100 is not limited to this configuration. Rather, the electrical circuit may alternatively include only a single type of one or more of the illustrated indicators, e.g., one or more audible indicators, one or more visual indicators or one or more tactile indicators, or alternatively still may include any combination of one or more of these indicator types. The instructions stored in the memory 65 may accordingly program the processor 62 to activate any one or combination of one or more of such indicator types according to any one or more indications, indication patterns and/or indication sequences.

In the illustrated embodiment, the electrical circuit 100 further includes a voltage regulator circuit 102 having inputs electrically connected to two electrical wires within the electrical cable 48 that is electrically connected to the electrical connector 50. The two electrical wires connect to positive voltage and ground inputs of the voltage regulator circuit 102, and also to two corresponding positive voltage and ground outputs of an external voltage source 106 via another electrical connector 104 that is configured to electrically connect to the electrical connector 50. The voltage source 106 may be, for example, but should not be limited to, the battery of the motor vehicle carrying the coupling apparatus 30, the ignition line, e.g., switched battery, of the motor vehicle, or the like. In any case, the voltage regulator has positive voltage and ground reference outputs that are electrically connected to the processor 62, the sensor 64, the audible indicator driver circuit 68 in embodiments that include the audible indicator driver circuit 68, the visual indicator driver circuit 70 in embodiments that include the visual indicator driver circuit 70, and the tactile indicator driver circuit 72 in embodiments that include the tactile indicator driver circuit 72. The voltage regulator circuit 102 is conventional, and is configured to covert the voltage produced by the voltage source 106, e.g., 12 or 24 volts, to a constant reduced voltage, e.g., 5 volts, suitable for operation of the remaining circuitry in the electrical circuit 100. Alternatively, the reduced voltage may be applied only to a subset of the electrical circuits, e.g., to the processor 62 and the sensor 64, and the voltage supplied by the voltage source 106 may be applied directly to one or more of the remaining electrical circuits, e.g., the audible indicator driver circuit 68, the visual indicator driver circuit 70 and/or the tactile indicator driver circuit 72. Alternatively still, the voltage regulator 102 may be omitted, and the voltage supplied by the voltage source 106 may be supplied to all circuitry in the electrical circuit 100 that requires a voltage supply.

In some embodiments, as illustrate by dashed-line representation in FIG. 10, the electrical circuit 100 includes a switch 76 having a voltage input that is electrically connected to the positive line of the voltage source 106 and a voltage output that is electrically connected to a third electrical wire of the electrical cable 48. The electrical connectors 50 and 104 electrically connect the voltage output of the switch 76 to at least one external indicator 108. A control input of the switch 76 is electrically connected to an output of the processor 62, and the instructions stored in the memory 65 are executable by the processor 62 to control the switch 76 to apply the voltage produced by the voltage source to the external indicator 108 to activate the external indicator when the sensor 64 detects disengagement of the coupling member 32 from the coupling apparatus 30. The memory 65 may be programmed, as described hereinabove, to activate the external indicator in any desired manner, e.g., with any desired single or repeating pattern and/or sequence. The switch 76 may be implemented in the form of, for example, a conventional relay or other conventional electrical or electronic switch, and the external indicator 108 may be or include any visual, audible and/or tactile indicator that is external to the coupling apparatus 30. Examples of the external indicator include, but should not be limited to, a dome light, dash-mounted lamp or other interior lamp of the motor vehicle carrying the coupling apparatus 30, chime, horn or other audible indicator carried by the motor vehicle, and/or any tactile indicator carried by the motor vehicle. In some embodiments, the switch 76 and external indicator 108 may be used to supplement any of the one or more indicators 66, 46A, 46B and/or 74 carried by the coupling apparatus 100, and in other embodiments, the coupling apparatus may not include any of the one or more indicators 66, 46A, 46B and 74, and the one or more external indicators may be the sole indicator(s) used to indicate the disengaged coupling member 32 condition.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected. For example, while the instructions stored in the memory 65 of the processor 62 of the coupling apparatus 30 have been described herein being executable by the processor 62 to control one or more indicators, based on the signal produced by the sensor 64, to indicate when the coupling apparatus 30 is not engaged with the coupling member 32, the instructions stored in the memory 65 may alternatively or additionally include instructions that are executable by the processor 62 to control one or more internal or external indicators, based on the signal produced by the sensor 64, to indicate when the coupling apparatus 30 is engaged with the coupling member 32. In some such embodiments, for example, one of the visual indicators 46A, 46B may be used to indicate the engaged condition and the other may be used to indicate the disengaged condition. The two visual indicators 46A, 46B in this embodiment may, for example, be different color indicators, or may be the identically colored lamps or LEDs but operated at different activation frequencies. In other example embodiments, more or fewer visual indicators may be provided and activated in a manner that provide for a visual distinction between the engaged and disengaged conditions. In these or other embodiments, the audible and/or tactile indicators 66, 74, if included, may be operated differently, e.g., at different operating frequencies, to provide for corresponding audible and/or tactile distinction between the engaged and disengaged conditions.

1-23. (canceled)

24. A restraint system for a motor vehicle, comprising:
a coupling member,
a coupling apparatus configured to receive and engage the coupling member,
a sensor configured to produce a sensor signal corresponding to a position of the coupling member relative to the coupling apparatus,
a latch plate carried by and movable relative to the coupling apparatus, the coupling member moving the latch plate to a position at which the sensor signal indicates that the coupling apparatus is engaged with the coupling member when the coupling apparatus receives and engages the coupling member, and wherein the sensor signal otherwise indicates that the coupling apparatus is not engaged with the coupling member,
at least one indicator, and
an electrical circuit configured to activate the at least one indicator if the sensor signal indicates that the coupling apparatus is not engaged with the coupling member.

25. The restraint system of claim 24 wherein the latch plate includes a sensing structure,
and wherein the sensor signal indicates that the coupling apparatus is engaged with the coupling member when the sensing structure is positioned within sensing distance of the sensor.

26. The restraint system of claim 27 wherein the sensing structure comprises a magnet,
and wherein the sensor comprises a Hall effect sensor.

27. The restraint system of claim 24 wherein the electrical circuit is configured to deactivate the at least one indicator if the sensor signal indicates that the coupling apparatus is engaged with the coupling member

28. The restraint system of claim 24 wherein the at least one indicator comprises at least one of an audible indicator, a visual indicator and a tactile indicator.

29. The restraint system of claim 24 wherein the coupling member comprises a tongue member and the coupling apparatus comprises a buckle member.

30. The restraint system of claim 24 wherein the buckle member is mounted to an occupant seat carried by the motor vehicle.

31. The restraint system of claim 24 wherein the electrical circuit comprises a processor including a memory having stored therein instructions that are executable by the processor to activate the at least one indicator if the sensor signal indicates that the coupling apparatus is not engaged with the coupling member.

32. The restraint system of claim 31 wherein the instructions stored in the memory include instructions that are executable by the processor to activate the at least one indicator according to a predetermined indication pattern.

33. The restraint system of claim 31 wherein the instructions stored in the memory include instructions that are executable by the processor to sequentially activate the at least one indicator according to a predetermined indication pattern.

34. The restraint system of claim 33 wherein the instructions stored in the memory include instructions that are executable by the processor to sequentially activate the at least one indicator according to the predetermined indication pattern with a predetermined time delay between each activation of the at least one indicator according to the predetermined indication pattern.

35. The restraint system of claim 24 wherein the at least one indicator comprises at least one light emitting diode carried by the coupling apparatus, the at least one light emitting diode visible externally to the coupling apparatus when activated.

36. The restraint system of claim 35 wherein the at least one indicator further comprises at least one audible indicator carried by the coupling apparatus, the at least one audible indicator being audibly perceptible external to the coupling apparatus when activated.

37. The restraint system of claims 24 wherein the at least one indicator comprises an indicator external to the coupling apparatus.

38. The restraint system of claim 37 wherein the electrical circuit comprises:
a processor including a memory having stored therein instructions that are executable by the processor to activate the at least one indicator if the sensor signal indicates that the coupling apparatus is not engaged with the coupling member, and
a switch having a voltage input configured to receive voltage from a voltage source carried by the motor vehicle, a voltage output configured to be connected to the indicator external to the coupling apparatus, and a control input electrically connected to the processor,
and wherein the instructions stored in the memory include instructions that are executable by the processor to control the switch via the control input thereof to activate the indicator external to the coupling apparatus if the sensor signal indicates that the coupling apparatus is not engaged with the coupling member.

39. A restraint system for a motor vehicle, comprising:
a coupling member,
a coupling apparatus configured to receive and engage the coupling member,
a first indicator,
a second indicator, and
an electrical circuit configured to determine whether the coupling member is engaged with the coupling apparatus and to activate the first indicator to indicate when the coupling apparatus is engaged with the coupling member and to activate the second indicator to indicate when the coupling apparatus is disengaged with the coupling member.

40. The restraint system of claim 39 wherein the first indicator includes at least one of a first visual indicator, a first audible indicator and a first tactile indicator, and the second indicator includes at least one of a corresponding second visual indicator, a second audible indicator and a second tactile indicator.

41. The restraint system of claim 39 further comprising:
a sensor configured to produce a sensor signal corresponding to a position of the coupling member relative to the coupling apparatus, and
a latch plate carried by and movable relative to the coupling apparatus, the coupling member moving the latch plate to a position at which the sensor signal indicates that the coupling apparatus is engaged with the coupling member when the coupling apparatus receives and engages the coupling member, and wherein the sensor signal otherwise indicates that the coupling apparatus is not engaged with the coupling member,
wherein the electrical circuit is configured to activate the first indicator if the sensor signal indicates that the coupling apparatus is engaged with the coupling member, and to activate the second indicator if the sensor signal indicates that the coupling apparatus is not engaged with the coupling member.

42. The restraint system of claim 41 wherein the latch plate includes a sensing structure,
and wherein the sensor signal indicates that the coupling apparatus is engaged with the coupling member when the sensing structure is positioned within sensing distance of the sensor.

43. The restraint system of claim 42 wherein the sensing structure comprises a magnet,
and wherein the sensor comprises a Hall effect sensor.
